(19) United States
(12) Patent Application Publication
(10) Pub. No.: US 2025/0059056 A1
(43) Pub. Date: Feb. 20, 2025

(54) METAL ORGANIC FRAMEWORK AND GAS ADSORBING MATERIAL

(71) Applicant: TOYOTA JIDOSHA KABUSHIKI KAISHA, Toyota-shi (JP)

(72) Inventor: Yoshio OHASHI, Gotemba-shi (JP)

(73) Assignee: TOYOTA JIDOSHA KABUSHIKI KAISHA, Toyota-shi (JP)

(21) Appl. No.: 18/756,470

(22) Filed: Jun. 27, 2024

(30) Foreign Application Priority Data
Aug. 15, 2023 (JP) 2023-132316

(51) Int. Cl. C01B 39/46; B01J 20/22; C07F 3/06

(52) U.S. Cl. CPC C01B 39/46; B01J 20/226; C07F 3/06; C01P 2002/72

(57) ABSTRACT

The present disclosure provides a novel metal organic framework and a gas adsorbing material containing the metal organic framework. The metal organic framework in one aspect of the embodiment contains zinc (Zn) and at least one ligand selected from 4-methylimidazole (4-MeIm), imidazole (Im), and benzimidazole (BzIm). When a mole ratio of the 4-MeIm, Im, and BzIm is x:y:z (4-MeIm:Im:BzIm), the mole ratio x:y:z falls within a polygonal region (including on a boundary line) having the following vertices in a ternary composition diagram: A (1:0:0), B (0.608:0.392:0), C (0.407:0.441:0.152), D (0.278:0.496:0.226), E (0:0.613:0.387), F (0:0.388:0.612), G (0.221:0.277:0.502), H (0.455:0.117:0.428), and I (0.563:0:0.437).

### CROSS REFERENCE TO RELATED APPLICATIONS

The present application claims priority from Japanese patent application JP 2023-132316 filed on Aug. 15, 2023, the entire content of which is hereby incorporated by reference into this application.

### BACKGROUND

### Technical Field

The present disclosure relates to a metal organic framework and a gas adsorbing material.

### Background Art

In recent years, studies on metal organic frameworks (MOFs) have been actively conducted. Among MOFs, a metal organic framework containing zinc and imidazoles, which is referred to as a zeolitic imidazole framework (ZIF), is known to have excellent thermal stability and chemical stability.

For example, J. Gandara-Loe et al., “New insights into the breathing phenomenon in ZIF-4”, J. Mater. Chem. A, 2019, 7. 14552-14558 discloses that cag-type Zn(Im)₂ exhibits N₂ adsorption/desorption properties.

### SUMMARY

The cag-type Zn(Im)₂ disclosed in J. Gandara-Loe et al., “New insights into the breathing phenomenon in ZIF-4”, J. Mater. Chem. A, 2019, 7. 14552-14558 has a problem of not having high gas adsorption/desorption properties at low pressure.

The present disclosure aims to provide a novel metal organic framework and a gas adsorbing material containing the metal organic framework.

The inventors have conducted intensive studies to solve the above-described problem, and have found a novel metal organic framework having a particular composition. The inventors have also found that the novel metal organic framework can be used as a gas adsorbing material, thus achieving the present disclosure.

Exemplary aspects of the embodiments are described as follows.

(1) A metal organic framework comprises zinc (Zn) and at least one ligand selected from 4-methylimidazole (4-MeIm), imidazole (Im), and benzimidazole (BzIm). When a mole ratio of the 4-MeIm, Im, and BzIm is x:y:z (4-MeIm:Im:BzIm), the mole ratio x:y:z falls within a polygonal region (including on a boundary line) having the following vertices in a ternary composition diagram:
A (1:0:0),
B (0.608:0.392:0),
C (0.407:0.441:0.152),
D (0.278:0.496:0.226),
E (0:0.613:0.387),
F (0:0.388:0.612),
G (0.221:0.277:0.502),
H (0.455:0.117:0.428), and
I (0.563:0:0.437).

(2) In the metal organic framework according to (1), the metal organic framework has an ACO-type topology.

(3) In the metal organic framework according to (1), diffraction peaks appear at diffraction angles (2θ) of at least 28.4±0.4°, 30.6±0.4°, and 35.2±0.4° in an X-ray powder diffraction measurement with a CuKα ray at an X-ray wavelength of 1.5418 Å.

(4) A gas adsorbing material comprises the metal organic framework according to any one of (1) to (3).

With the present disclosure, a novel metal organic framework and a gas adsorbing material containing the metal organic framework can be provided.

### BRIEF DESCRIPTION OF THE DRAWINGS

FIG. 1 illustrates a ternary composition diagram plotting the compositions obtained from ¹H-NMR measurements of 4-MeIm, Im, and BzIm constituting the respective products obtained in Examples and Comparative Examples;

FIG. 2A illustrates an X-ray diffraction diagram of products obtained in Examples 1 to 5 and FIG. 2B illustrates an X-ray diffraction diagram of products obtained in Examples 6 to 10;

FIG. 3A illustrates an X-ray diffraction diagram of products obtained in Examples 11 to 15 and FIG. 3B illustrates an X-ray diffraction diagram of products obtained in Examples 16 to 20;

FIG. 4A illustrates an X-ray diffraction diagram of products obtained in Comparative Examples 1 to 3 and FIG. 4B illustrates an X-ray diffraction diagram of products obtained in Comparative Examples 4 to 7;

FIG. 5 illustrates an X-ray diffraction diagram of products obtained in Comparative Examples 8 to 12; and

FIG. 6 illustrates N₂ adsorption amounts at 77K of products obtained in Examples 1, 4, 11, 15, and 16 and Comparative Examples 7 and 11.

### DETAILED DESCRIPTION

The following describes a metal organic framework and a gas adsorbing material according to the embodiment in detail. An aspect of the embodiment is a metal organic framework that contains zinc (Zn) and at least one ligand selected from 4-methylimidazole (4-MeIm), imidazole (Im), and benzimidazole (BzIm). When a mole ratio of the 4-MeIm, Im, and BzIm is x:y:z (4-MeIm:Im:BzIm), the mole ratio x:y:z falls within a polygonal region (including on a boundary line) having the following vertices in a ternary composition diagram:
A (1:0:0),
B (0.608:0.392:0),
C (0.407:0.441:0.152),
D (0.278:0.496:0.226),
E (0:0.613:0.387),
F (0:0.388:0.612),
G (0.221:0.277:0.502),
H (0.455:0.117:0.428), and
I (0.563:0:0.437). An aspect of the embodiment is a gas adsorbing material that contains the metal organic framework.

### (Metal Organic Framework)

A metal organic framework, also commonly referred to as a MOF, is a material having a porous coordination network structure with a high surface area due to the interaction of metal and organic ligands. The metal organic framework of the embodiment contains zinc (Zn) and at least one ligand selected from 4-methylimidazole (4-MeIm), imidazole (Im), and benzimidazole (BzIm), and a mole ratio of the 4-MeIm, Im, and BzIm falls within the above-described particular range. The metal organic framework whose mole ratio of 4-MeIm, Im, and BzIm falls within the polygonal region (including on the boundary line) having the above-described nine points A to I as vertices in the ternary composition diagram is a novel substance and has excellent gas adsorption property. In view of this, the metal organic framework of the embodiment can be used as a gas adsorbing material.

In the metal organic framework, zinc is usually present as zinc cations, in particular, divalent cations (Zn²⁺). In the metal organic framework, 4-methylimidazole (4-MeIm), imidazole (Im), and benzimidazole (BzIm) are each usually present as monovalent anions (4-MeIm⁻, Im⁻, BzIm⁻, respectively). That is, in the present disclosure, the metal organic framework containing zinc (Zn) and at least one ligand selected from 4-methylimidazole (4-MeIm), imidazole (Im), and benzimidazole (BzIm) can also be read as a metal organic framework containing a cation of zinc (Zn) and an anionic ligand of at least one imidazoles selected from 4-methylimidazole (4-MeIm), imidazole (Im), and benzimidazole (BzIm).

From the aspect of gas adsorption property, when a mole ratio of the 4-MeIm, Im, and BzIm is x:y:z (4-MeIm:Im:BzIm), the metal organic framework of the embodiment may have the mole ratio x:y:z that falls within a polygonal region (including on a boundary line) having the following vertices in a ternary composition diagram:
A (1:0:0),
B″ (0.655:0.345:0),
C″ (0.195:0.526:0.279),
D″ (0:0.535:0.465),
E″ (0:0.438:0.562),
F″ (0.161:0.321:0.518), and
G″ (0.629:0:0.371).

The metal organic framework of the embodiment may have an ACO-type topology in one aspect. The metal organic framework may have the ACO-type topology from the aspect of gas adsorption property. The fact that the metal organic framework has the ACO-type topology can be confirmed, for example, by the method described in Examples, that is, an X-ray powder diffraction measurement. When the metal organic framework of the embodiment has the ACO-type topology, “a case of having only the ACO-type topology” and “a case of having the ACO-type topology and another structure, such as unknown structure described later” are encompassed.

In the metal organic framework of the embodiment, diffraction peaks may appear at diffraction angles (2θ) of at least 28.4±0.4°, 30.6±0.4°, and 35.2±0.4° in the X-ray powder diffraction measurement with a CuKα ray at an X-ray wavelength of 1.5418 Å in one aspect. The metal organic framework containing zinc and at least one ligand selected from 4-methylimidazole, imidazole, and benzimidazole in which the diffraction peaks appear has not been known, and the diffraction peaks indicate an unknown structure. The X-ray powder diffraction measurement can be carried out, for example, by the method described in Examples. When the metal organic framework of the embodiment has the unknown structure, “a case of having only the unknown structure” and “a case of having the unknown structure and another structure, such as the ACO-type topology” are encompassed.

The process for producing the metal organic framework of the embodiment is not particularly limited. For example, the metal organic framework can be synthesized by adding a powder of zinc oxide, at least one imidazoles selected from 4-methylimidazole, imidazole, and benzimidazole, and hard balls such as zirconia balls to a ball mill vessel, together with a solvent as necessary, and mechanically mixing them using a ball mill. Examples of the solvent include N,N-dimethylformamide. Specific examples of the method for producing the metal organic framework of the embodiment include the method described in Examples. In the method, oxygen ions of zinc oxide and hydrogen ions of imidazoles are eliminated to give water as a by-product. The metal organic framework of the embodiment can be obtained by removing water, the solvent, and the like after the synthesis. The amounts of zinc oxide, imidazoles, and the like used as raw materials can be appropriately set with reference to values of Examples described later.

### (Gas Adsorbing Material)

The gas adsorbing material of the embodiment contains the above-described metal organic framework of the embodiment. The gas adsorbing material of the embodiment may be the above-described metal organic framework of the embodiment in one aspect.

The gas adsorbing material of the embodiment may contain other components, for example, a metal such as manganese (Mn), iron (Fe), or cobalt (Co), and an organic substance such as 2-methylimidazole (2-MeIm), 4-ethylimidazole (4-EtIm), 2-methylbenzimidazole (2-MeBzIm), 5-methylbenzimidazole (5-MeBzIm), or the like. The metal organic framework may be supported on another material.

The gas adsorbing material of the embodiment is capable of adsorbing various gaseous substances, and is capable of adsorbing, for example, nitrogen gas and organic substances. Examples of the organic substances include methane, ethane, propane, and butane. The gas adsorbing material can be used in a variety of applications. Examples of the applications of the gas adsorbing material include a gas adsorption system using the gas adsorbing material, a gas separation system using the gas adsorbing material, and a gas storage system using the gas adsorbing material.

### EXAMPLES

The following describes the embodiment with Examples, but the present disclosure is not limited to these examples.

### [Reagent]

The following reagents were used in Examples and Comparative Examples.
Zinc oxide (ZnO): FUJIFILM Wako Pure Chemical Corporation, 0.02 μm, Practical Grade, 95.0+%
4-methylimidazole (4-MeIm): Tokyo Chemical Industry Co., Ltd., >98.0%
Imidazole (Im): Tokyo Chemical Industry Co., Ltd., >98.0%
Benzimidazole (BzIm): Tokyo Chemical Industry Co., Ltd., >98.0%
Ethanol (EtOH): Kanto Chemical Co., Inc., Guaranteed Reagent, 94.8% to 95.8%
N,N-dimethylformamide (DMF): FUJIFILM Wako Pure Chemical Corporation, Super Dehydrated, for Organic Synthesis, 99.5+%

### Example 1

1.221 g (15 mmol) of zinc oxide, 2.463 g (30 mmol) of 4-methylimidazole, 3 mL of N,N-dimethylformamide, and 50 g of zirconia balls with q 5 mm were added to a 45 mL ball mill vessel.

The ball mill vessel was placed in a planetary ball mill apparatus and rotated at 700 rpm for 3 hours. The content was collected from the ball mill vessel and the zirconia balls were removed.

50 mL of ethanol was added to the content and stirred, and subjected to centrifugation at 16000 rpm for 15 minutes to remove a supernatant. The operation of adding the ethanol, centrifugation, and removing the supernatant was repeated four times in total.

A precipitate collected by removing the supernatant was dried at 60° C. overnight while reducing pressure to obtain a powder.

### Example 2

A powder was obtained similarly to Example 1, except that 2.463 g (30 mmol) of 4-methylimidazole was changed to 2.155 g (26.25 mmol) of 4-methylimidazole and 0.255 g (3.75 mmol) of imidazole.

### Example 3

A powder was obtained similarly to Example 1, except that 2.463 g (30 mmol) of 4-methylimidazole was changed to 1.847 g (22.5 mmol) of 4-methylimidazole, 0.255 g (3.75 mmol) of imidazole, and 0.443 g (3.75 mmol) of benzimidazole.

### Example 4

A powder was obtained similarly to Example 1, except that 2.463 g (30 mmol) of 4-methylimidazole was changed to 1.847 g (22.5 mmol) of 4-methylimidazole and 0.886 g (7.5 mmol) of benzimidazole.

### Example 5

A powder was obtained similarly to Example 1, except that 2.463 g (30 mmol) of 4-methylimidazole was changed to 1.539 g (18.75 mmol) of 4-methylimidazole, 0.511 g (7.5 mmol) of imidazole, and 0.443 g (3.75 mmol) of benzimidazole.

### Example 6

A powder was obtained similarly to Example 1, except that 2.463 g (30 mmol) of 4-methylimidazole was changed to 1.232 g (15 mmol) of 4-methylimidazole, 0.766 g (11.25 mmol) of imidazole, and 0.443 g (3.75 mmol) of benzimidazole.

### Example 7

A powder was obtained similarly to Example 1, except that 2.463 g (30 mmol) of 4-methylimidazole was changed to 1.232 g (15 mmol) of 4-methylimidazole, 0.511 g (7.5 mmol) of imidazole, and 0.886 g (7.5 mmol) of benzimidazole.

### Example 8

A powder was obtained similarly to Example 1, except that 2.463 g (30 mmol) of 4-methylimidazole was changed to 0.924 g (11.25 mmol) of 4-methylimidazole, 1.021 g (15 mmol) of imidazole, and 0.443 g (3.75 mmol) of benzimidazole.

### Example 9

A powder was obtained similarly to Example 1, except that 2.463 g (30 mmol) of 4-methylimidazole was changed to 0.924 g (11.25 mmol) of 4-methylimidazole, 0.511 g (7.5 mmol) of imidazole, and 1.329 g (11.25 mmol) of benzimidazole.

### Example 10

A powder was obtained similarly to Example 1, except that 2.463 g (30 mmol) of 4-methylimidazole was changed to 0.821 g (10 mmol) of 4-methylimidazole, 0.681 g (10 mmol) of imidazole, and 1.181 g (10 mmol) of benzimidazole.

### Example 11

A powder was obtained similarly to Example 1, except that 2.463 g (30 mmol) of 4-methylimidazole was changed to 0.616 g (7.5 mmol) of 4-methylimidazole, 1.021 g (15 mmol) of imidazole, and 0.886 g (7.5 mmol) of benzimidazole.

### Example 12

A powder was obtained similarly to Example 1, except that 2.463 g (30 mmol) of 4-methylimidazole was changed to 0.616 g (7.5 mmol) of 4-methylimidazole, 0.766 g (11.25 mmol) of imidazole, and 1.329 g (11.25 mmol) of benzimidazole.

### Example 13

A powder was obtained similarly to Example 1, except that 2.463 g (30 mmol) of 4-methylimidazole was changed to 0.308 g (3.75 mmol) of 4-methylimidazole, 0.766 g (11.25 mmol) of imidazole, and 1.772 g (15 mmol) of benzimidazole.

### Example 14

A powder was obtained similarly to Example 1, except that 2.463 g (30 mmol) of 4-methylimidazole was changed to 1.277 g (18.75 mmol) of imidazole and 1.329 g (11.25 mmol) of benzimidazole.

### Example 15

A powder was obtained similarly to Example 1, except that 2.463 g (30 mmol) of 4-methylimidazole was changed to 1.021 g (15 mmol) of imidazole and 1.772 g (15 mmol) of benzimidazole.

### Example 16

A powder was obtained similarly to Example 1, except that 2.463 g (30 mmol) of 4-methylimidazole was changed to 1.847 g (22.5 mmol) of 4-methylimidazole and 0.511 g (7.5 mmol) of imidazole.

### Example 17

A powder was obtained similarly to Example 1, except that 2.463 g (30 mmol) of 4-methylimidazole was changed to 1.539 g (18.75 mmol) of 4-methylimidazole and 0.766 g (11.25 mmol) of imidazole.

### Example 18

A powder was obtained similarly to Example 1, except that 2.463 g (30 mmol) of 4-methylimidazole was changed to 1.539 g (18.75 mmol) of 4-methylimidazole and 1.329 g (11.25 mmol) of benzimidazole.

### Example 19

A powder was obtained similarly to Example 1, except that 2.463 g (30 mmol) of 4-methylimidazole was changed to 1.232 g (15 mmol) of 4-methylimidazole, 0.255 g (3.75 mmol) of imidazole, and 1.329 g (11.25 mmol) of benzimidazole.

### Example 20

A powder was obtained similarly to Example 1, except that 2.463 g (30 mmol) of 4-methylimidazole was changed to 0.308 g (3.75 mmol) of 4-methylimidazole, 1.277 g (18.75 mmol) of imidazole, and 0.886 g (7.5 mmol) of benzimidazole.

### Comparative Example 1

A powder was obtained similarly to Example 1, except that 2.463 g (30 mmol) of 4-methylimidazole was changed to 1.232 g (15 mmol) of 4-methylimidazole and 1.772 g (15 mmol) of benzimidazole.

### Comparative Example 2

A powder was obtained similarly to Example 1, except that 2.463 g (30 mmol) of 4-methylimidazole was changed to 0.616 g (7.5 mmol) of 4-methylimidazole, 0.511 g (7.5 mmol) of imidazole, and 1.7726 g (15 mmol) of benzimidazole.

### Comparative Example 3

A powder was obtained similarly to Example 1, except that 2.463 g (30 mmol) of 4-methylimidazole was changed to 0.766 g (11.25 mmol) of imidazole and 2.215 g (18.75 mmol) of benzimidazole.

### Comparative Example 4

A powder was obtained similarly to Example 1, except that 2.463 g (30 mmol) of 4-methylimidazole was changed to 0.616 g (7.5 mmol) of 4-methylimidazole, 0.255 g (3.75 mmol) of imidazole, and 2.215 g (18.75 mmol) of benzimidazole.

### Comparative Example 5

A powder was obtained similarly to Example 1, except that 2.463 g (30 mmol) of 4-methylimidazole was changed to 0.616 g (7.5 mmol) of 4-methylimidazole and 2.658 g (22.5 mmol) of benzimidazole.

### Comparative Example 6

A powder was obtained similarly to Example 1, except that 2.463 g (30 mmol) of 4-methylimidazole was changed to 0.511 g (7.5 mmol) of imidazole and 2.658 g (22.5 mmol) of benzimidazole.

### Comparative Example 7

A powder was obtained similarly to Example 1, except that 2.463 g (30 mmol) of 4-methylimidazole was changed to 3.544 g (30 mmol) of benzimidazole.

### Comparative Example 8

A powder was obtained similarly to Example 1, except that 2.463 g (30 mmol) of 4-methylimidazole was changed to 1.232 g (15 mmol) of 4-methylimidazole and 1.021 g (15 mmol) of imidazole.

### Comparative Example 9

A powder was obtained similarly to Example 1, except that 2.463 g (30 mmol) of 4-methylimidazole was changed to 0.616 g (7.5 mmol) of 4-methylimidazole and 1.532 g (22.5 mmol) of imidazole.

### Comparative Example 10

A powder was obtained similarly to Example 1, except that 2.463 g (30 mmol) of 4-methylimidazole was changed to 0.616 g (7.5 mmol) of 4-methylimidazole, 1.277 g (18.75 mmol) of imidazole, and 0.443 g (3.75 mmol) of benzimidazole.

### Comparative Example 11

A powder was obtained similarly to Example 1, except that 2.463 g (30 mmol) of 4-methylimidazole was changed to 2.042 g (30 mmol) of imidazole.

### Comparative Example 12

A powder was obtained similarly to Example 1, except that 2.463 g (30 mmol) of 4-methylimidazole was changed to 1.532 g (22.5 mmol) of imidazole and 0.886 g (7.5 mmol) of benzimidazole.

### [Analysis and Evaluation of Product]

### (¹H-NMR Measurement)

The powders (products, MOFs) obtained in the respective Examples and Comparative Examples were decomposed and dissolved with a deuterated solvent, and then ¹H-NMR spectra of the solutions were measured to determine the ratios of 4-methylimidazole (4-MeIm), imidazole (Im), and benzimidazole (BzIm) contained in the products based on the integration ratios. The ratio of each component was calculated with a sum of 4-MeIm, Im, and BzIm as 100 mol %.

The decomposition condition and the measurement device are described below.

Decomposition condition: A product is decomposed with heavy water (D₂O) solution of 10 wt % deuterated sulfuric acid (D₂SO₄)

Measurement device: INOVA 300 (Agilent Technologies)

### (X-Ray Diffraction Measurement)

X-ray diffraction measurements were performed on the powders (products, MOFs) obtained in the respective Examples and Comparative Examples to confirm the crystalline structure.

The measurement device and the measurement condition are described below.

Measurement device: RINT RAPID II (Rigaku Corporation)

Measurement condition: Voltage 50 V, current 100 mA, collimator diameter φ 0.3, sample angle ω 5°, CuKα ray at X-ray wavelength of 1.5418 Å

X-ray diffraction diagrams of ACO-type Zn(4-MeIm)₂, cag-type Zn(Im)₂, and SOD-type Zn(BzIm)₂ were simulated and compared with those of the products. The cag-type Zn(Im)₂ is a known substance reported under the name of ZIF-4, and the SOD-type Zn(BzIm)₂ is a known substance reported under the name of ZIF-7 (or ZIF-7-I).

### (N₂ Adsorption Isotherm Measurement)

The products obtained in Examples 1, 4, 11, 15, and 16, and Comparative Examples 7 and 11 were each pretreated under the following condition, and then N₂ adsorption isotherms were measured. N₂ adsorption amounts at N₂ relative pressure of 0.01% were determined as N₂ adsorption amounts.

The pretreatment device, the pretreatment condition, the measurement device, and the measurement condition are described below.

Pretreatment device: BELPREP vac II (MicrotracBEL Corp.)

Pretreatment condition: Heated at a degree of vacuum of <10⁻² Pa, at 160° C. for 6 hours

Measurement device: BELSORP max (MicrotracBEL Corp.)

Measurement condition: N₂ adsorption amount at a temperature of 77K and N₂ relative pressure of 0 to 99% is measured

When the equilibrium determination time at the time of measurement was long and liquid nitrogen for cooling was depleted, the measurement was interrupted. The adsorption isotherm up to N₂ relative pressure of 100% was not measured for such a sample.

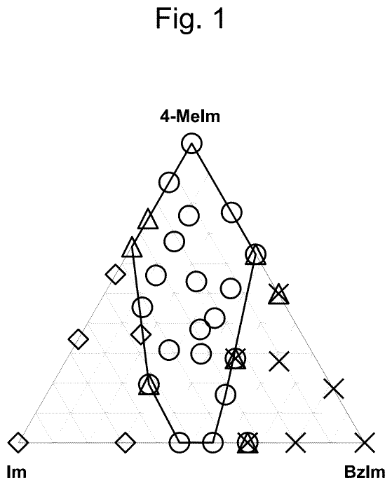

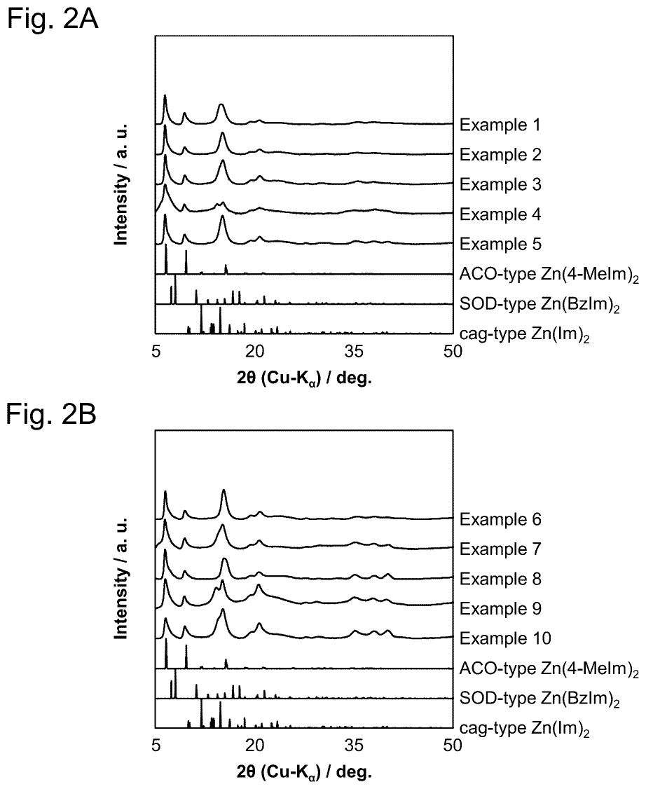

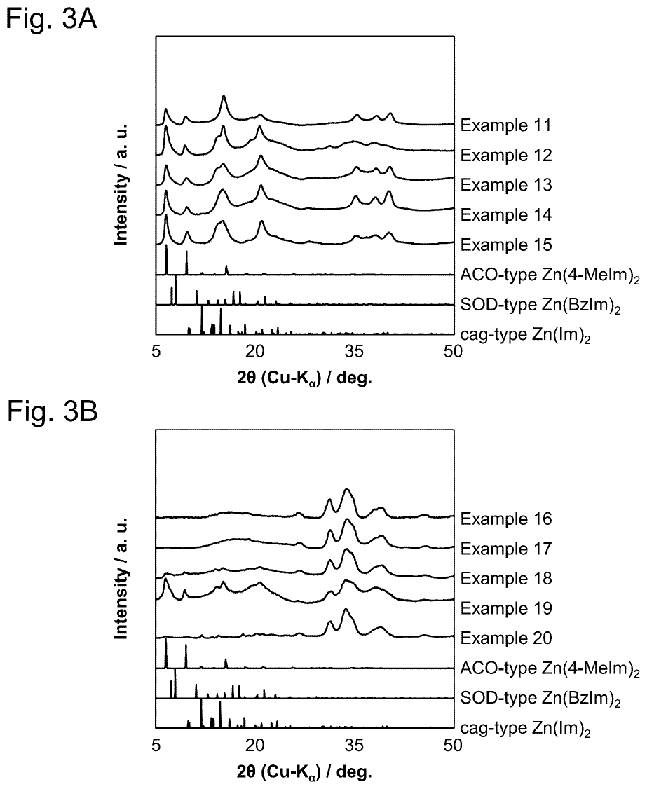

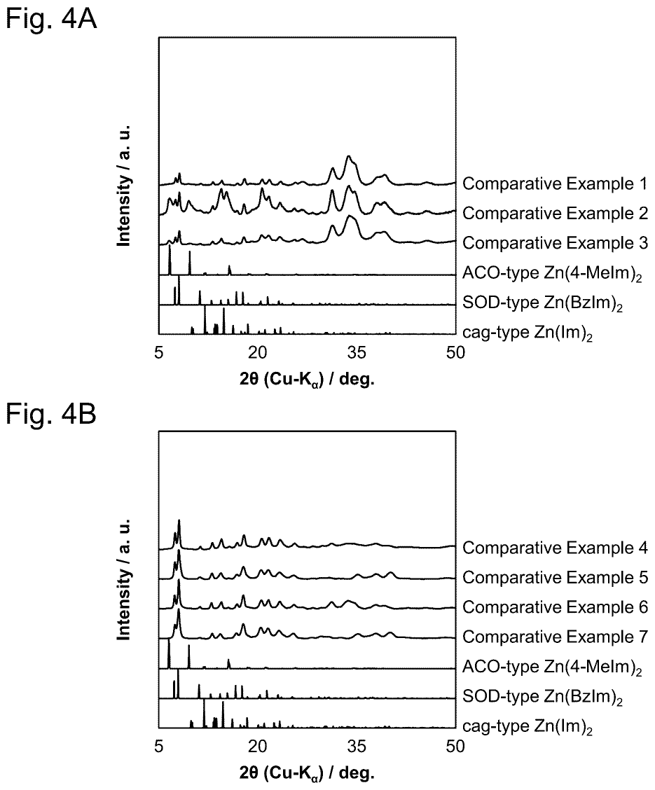

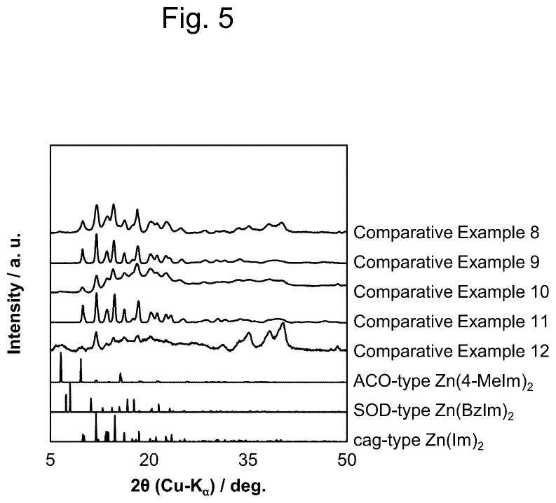

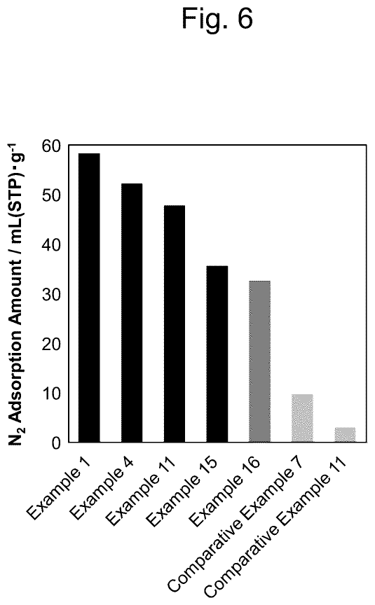

For the respective Examples and Comparative Examples, the charge-in compositions (usage) of 4-MeIm, Im, and BzIm, the compositions (analysis results) obtained from the ¹H-NMR measurements of 4-MeIm, Im, and BzIm of the respective obtained products, and the crystalline structures of the respective products are shown in Table 1 and Table 2. FIG. 1 illustrates a ternary composition diagram plotting the compositions obtained from the ¹H-NMR measurements of 4-MeIm, Im, and BzIm constituting the respective products obtained in Examples and Comparative Examples. In FIG. 1, Symbol (∘) denotes an ACO type, Symbol (Δ) denotes an unknown structure, Symbol (⋄) denotes a cag type, and Symbol (x) denotes a SOD type. The X-ray diffraction diagrams obtained by the X-ray diffraction measurements of the products of the respective Examples and Comparative Examples are shown in FIGS. 2A to 5. FIGS. 2A to 5 also show simulated results of the X-ray diffraction diagrams of ACO-type Zn(4-MeIm)₂, cag-type Zn(Im)₂, and SOD-type Zn(BzIm)₂. FIG. 6 shows N₂ adsorption amounts at 77K of the products obtained in Examples 1, 4, 11, 15, and 16 and Comparative Examples 7 and 11.

TABLE 1

| | Charge-in Composition (mol %) | | | Analysis Result (mol %) | | | Crystalline Structure | | |
|---|---|---|---|---|---|---|---|---|---|
| | 4-MeIm | Im | BzIm | 4-MeIm | Im | BzIm | First Phase | Second Phase | Third Phase |
| Example 1 | 100.0 | 0.0 | 0.0 | 100.0 | 0.0 | 0.0 | ACO-type | — | — |
| Example 2 | 87.5 | 12.5 | 0.0 | 87.0 | 13.0 | 0.0 | ACO-type | — | — |
| Example 3 | 75.0 | 12.5 | 12.5 | 75.8 | 12.9 | 11.4 | ACO-type | — | — |
| Example 4 | 75.0 | 0.0 | 25.0 | 76.9 | 0.0 | 23.1 | ACO-type | — | — |
| Example 5 | 62.5 | 25.0 | 12.5 | 67.1 | 21.5 | 11.4 | ACO-type | — | — |
| Example 6 | 50.0 | 37.5 | 12.5 | 55.9 | 32.4 | 11.7 | ACO-type | — | — |
| Example 7 | 50.0 | 25.0 | 25.0 | 53.8 | 21.8 | 24.4 | ACO-type | — | — |
| Example 8 | 37.5 | 50.0 | 12.5 | 45.2 | 41.6 | 13.1 | ACO-type | — | — |
| Example 9 | 37.5 | 25.0 | 37.5 | 41.7 | 22.5 | 35.8 | ACO-type | — | — |
| Example 10 | 33.3 | 33.3 | 33.3 | 37.9 | 28.5 | 33.6 | ACO-type | — | — |
| Example 11 | 25.0 | 50.0 | 25.0 | 30.9 | 41.0 | 28.1 | ACO-type | — | — |
| Example 12 | 25.0 | 37.5 | 37.5 | 29.7 | 32.3 | 38.0 | ACO-type | — | — |
| Example 13 | 12.5 | 37.5 | 50.0 | 16.1 | 32.1 | 51.8 | ACO-type | — | — |
| Example 14 | 0.0 | 62.5 | 37.5 | 0.0 | 53.5 | 46.5 | ACO-type | — | — |
| Example 15 | 0.0 | 50.0 | 50.0 | 0.0 | 43.8 | 56.2 | ACO-type | — | — |
| Example 16 | 75.0 | 25.0 | 0.0 | 74.9 | 25.1 | 0.0 | Unknown Phase | — | — |
| Example 17 | 62.5 | 37.5 | 0.0 | 65.5 | 34.5 | 0.0 | Unknown Phase | — | — |
| Example 18 | 62.5 | 0.0 | 37.5 | 62.9 | 0.0 | 37.1 | Unknown Phase | ACO-type | — |
| Example 19 | 50.0 | 12.5 | 37.5 | 51.5 | 12.9 | 35.6 | ACO-type | Unknown Phase | — |
| Example 20 | 12.5 | 62.5 | 25.0 | 19.5 | 52.6 | 27.9 | Unknown Phase | ACO-type | — |

TABLE 2

| | Charge-in Composition (mol %) | | | Analysis Result (mol %) | | | Crystalline Structure | | |
|---|---|---|---|---|---|---|---|---|---|
| | 4-MeIm | Im | BzIm | 4-MeIm | Im | BzIm | First Phase | Second Phase | Third Phase |
| Comparative Example 1 | 50.0 | 0.0 | 50.0 | 49.7 | 0.0 | 50.3 | Unknown Phase | SOD-type | — |
| Comparative Example 2 | 25.0 | 25.0 | 50.0 | 28.2 | 23.3 | 48.5 | Unknown Phase | SOD-type | ACO-type |
| Comparative Example 3 | 0.0 | 37.5 | 62.5 | 0.0 | 33.8 | 66.2 | Unknown Phase | SOD-type | ACO-type |
| Comparative Example 4 | 25.0 | 12.5 | 62.5 | 27.2 | 11.1 | 61.7 | SOD-type | — | — |
| Comparative Example 5 | 25.0 | 0.0 | 75.0 | 18.0 | 0.0 | 82.0 | SOD-type | — | — |
| Comparative Example 6 | 0.0 | 25.0 | 75.0 | 0.0 | 20.0 | 80.0 | SOD-type | — | — |
| Comparative Example 7 | 0.0 | 0.0 | 100.0 | 0.0 | 0.0 | 100.0 | SOD-type | — | — |
| Comparative Example 8 | 50.0 | 50.0 | 0.0 | 56.1 | 43.9 | 0.0 | cag-type | — | — |
| Comparative Example 9 | 25.0 | 75.0 | 0.0 | 34.6 | 65.4 | 0.0 | cag-type | — | — |
| Comparative Example 10 | 25.0 | 62.5 | 12.5 | 36.1 | 46.6 | 17.3 | cag-type | — | — |
| Comparative Example 11 | 0.0 | 100.0 | 0.0 | 0.0 | 100.0 | 0.0 | cag-type | — | — |
| Comparative Example 12 | 0.0 | 75.0 | 25.0 | 0.0 | 69.1 | 30.9 | cag-type | — | — |

The upper limit value and/or lower limit value of numerical ranges described herein are allowed to have appropriate ranges specified by combining each of them conveniently. For example, the appropriate ranges are allowed to be specified by conveniently combining the upper limit values and the lower limit values of the numerical ranges, the appropriate ranges are allowed to be specified by conveniently combining the upper limit values of the numerical ranges, or the appropriate ranges are allowed to be specified by conveniently combining the lower limit values of the numerical ranges.

While the embodiment has been described in detail, specific configurations are not limited to the embodiment, and when there are changes of designs within the range not departing from the gist of the present disclosure, they are included in the present disclosure.

What is claimed is:

1. A metal organic framework comprising:
zinc (Zn); and
at least one ligand selected from 4-methylimidazole (4-MeIm), imidazole (Im), and benzimidazole (BzIm),
wherein when a mole ratio of the 4-MeIm, Im, and BzIm is x:y:z (4-MeIm:Im:BzIm), the mole ratio x:y:z falls within a polygonal region (including on a boundary line) having the following vertices in a ternary composition diagram:
A (1:0:0),
B (0.608:0.392:0),
C (0.407:0.441:0.152),
D (0.278:0.496:0.226),
E (0:0.613:0.387),
F (0:0.388:0.612),
G (0.221:0.277:0.502),
H (0.455:0.117:0.428), and
I (0.563:0:0.437).

2. The metal organic framework according to claim 1,
wherein the metal organic framework has an ACO-type topology.

3. The metal organic framework according to claim 1,
wherein diffraction peaks appear at diffraction angles (2θ) of at least 28.4±0.4°, 30.6±0.4°, and 35.2±0.4° in an X-ray powder diffraction measurement with a CuKα ray at an X-ray wavelength of 1.5418 Å.

4. A gas adsorbing material comprising
the metal organic framework according to claim 1.
